(19) United States
(12) Patent Application Publication
(10) Pub. No.: US 2008/0128422 A1
(43) Pub. Date: Jun. 5, 2008

(54) Vehicle trash system

(75) Inventors: Corey S. Adler, Thornhill (CA); Steve A. Copeland, King City (CA)

Correspondence Address: SAND & SEBOLT, AEGIS TOWER, SUITE 1100, 4940 MUNSON STREET, NW, CANTON, OH, 44718-3615, US

(73) Assignee: 2111081 ONTARIO LIMITED, Thornhill (CA)

(21) Appl. No.: 11/633,743

(22) Filed: Dec. 5, 2006

(51) Int. Cl. B60R 7/04; B65D 25/16; B65D 8/14

(52) U.S. Cl. 220/495.06; 224/275; 220/666; 220/619; 220/839

(57) ABSTRACT

A trash container assembly includes a trash receptacle movable between collapsed and expanded positions; and a seat mount for mounting the receptacle on the back of a seat assembly, usually within a vehicle such as an car. Typically, the receptacle includes an accordion type or other collapsible wall and a pair of rigid walls connected to the collapsible wall. A liquid-impermeable trash bag is disposed within the receptacle. A lid is connected to the receptacle and a compartment for pre-moistened wipes or the like is mounted on the lid. The lid and compartment may be positioned atop the receptacle in the expanded position and beside the compartment in the collapsed position. A sidewall of the receptacle may define a recess for receiving the compartment in the collapsed position. The seat mount may include one or more straps for looping around a headrest and the back of the seat assembly.

### BACKGROUND OF THE INVENTION

1. Technical Field

The present invention relates generally to a trash receptacle. More particularly, the invention relates to a trash receptacle for use in a vehicle such as an automobile. Specifically, the invention relates to such a trash receptacle which is configured to mount on the back of a seat, is expandable and may provide a separate compartment for pre-moistened wipes or the like.

2. Background Information

It is well known that when traveling in a vehicle such as an automobile, disposing of trash is a common problem, especially when taking a long trip. Often, trash winds up on the floor or in a bag seated on the floor or the like. When a passenger has a drink that is partially finished and that he wishes to dispose of, the remaining liquid in the drink container has the potential of spilling and making a substantial mess within the vehicle. Thus, there is a need in the art for a trash receptacle which is aesthetically pleasing, suited for retaining liquids without causing a mess and capable of maintaining a configuration which will retain the trash therein during various movements of car such as turning, braking and accelerating. The present invention solves this and other problems in the art.

### BRIEF SUMMARY OF THE INVENTION

The present invention provides a trash container assembly for use with a seat assembly having a seat and a back extending upwardly therefrom, the trash container assembly comprising a trash receptacle movable between collapsed and expanded positions; and a seat mount adapted for mounting the receptacle on the back of the seat assembly.

### BRIEF DESCRIPTION OF THE SEVERAL VIEWS OF THE DRAWINGS

FIG. 1 is a perspective view of the trash container assembly of the present invention as shown mounted on the back of a seat in the expanded position and showing the rear of the receptacle.

FIG. 2 is an enlarged perspective view similar to FIG. 1 showing the trash container assembly alone.

FIG. 3 is an exploded perspective view of the assembly in the expanded position showing the front of the receptacle.

FIG. 3A is a perspective view of the flexible bag.

FIG. 4 is a sectional view through the center of the assembly taken from the side showing the receptacle in the expanded position.

FIG. 5 is a perspective view similar to FIG. 2 showing the receptacle in the collapsed position.

FIG. 6 is a side elevational view of the assembly in the collapsed position.

FIG. 7 is a sectional view similar to FIG. 4 in the collapsed position.

FIG. 8 is a perspective view similar to FIG. 1 showing the receptacle mounted on the back of the seat in the collapsed position.

FIG. 9 is a view similar to FIG. 8 showing the receptacle in the expanded position with the lid open.

### DETAILED DESCRIPTION OF THE INVENTION

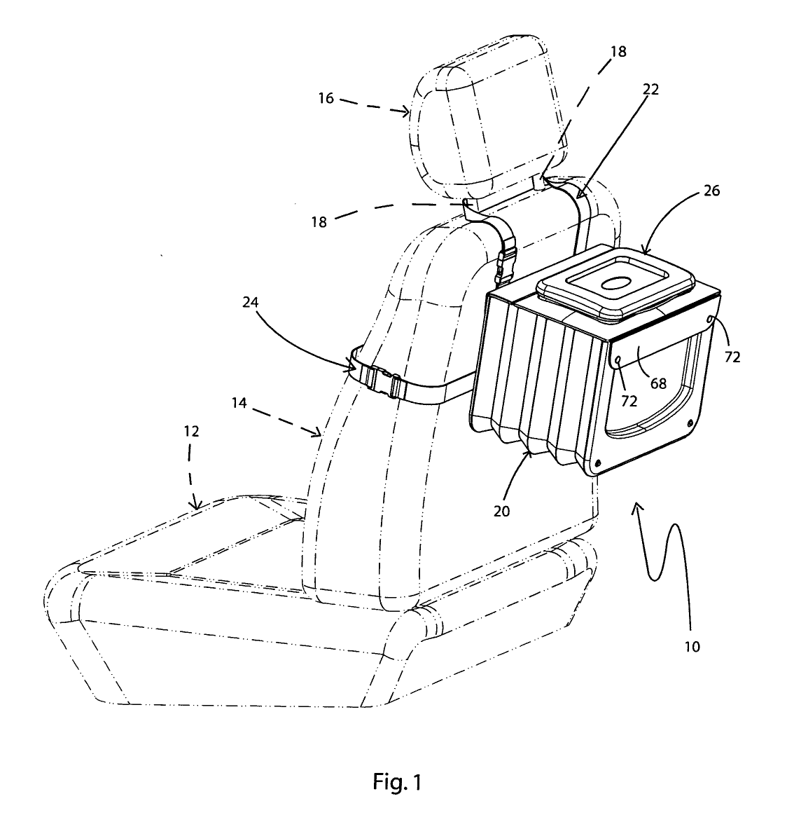

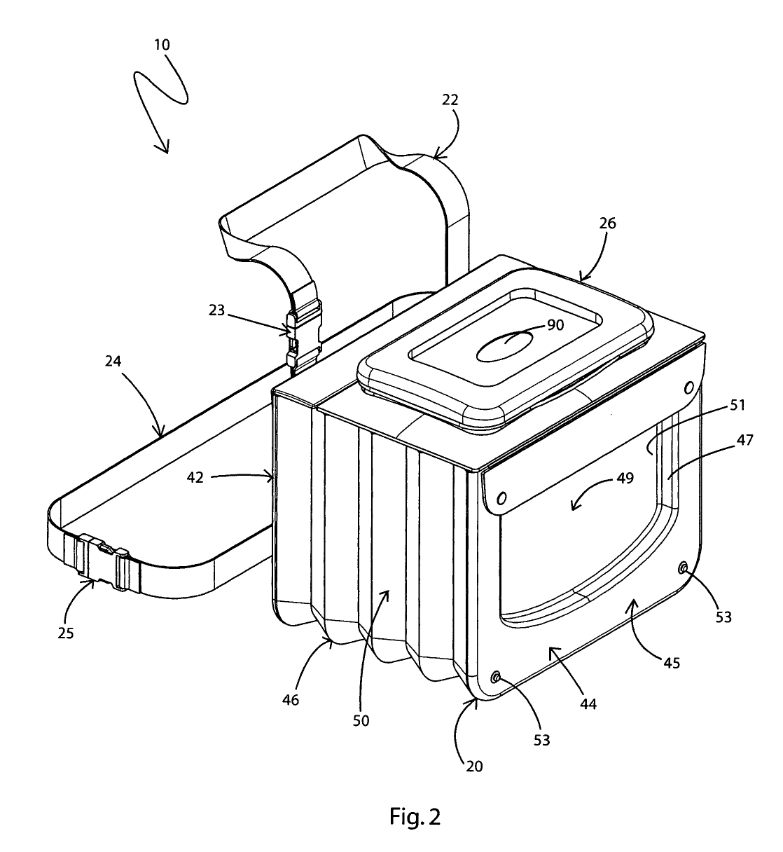

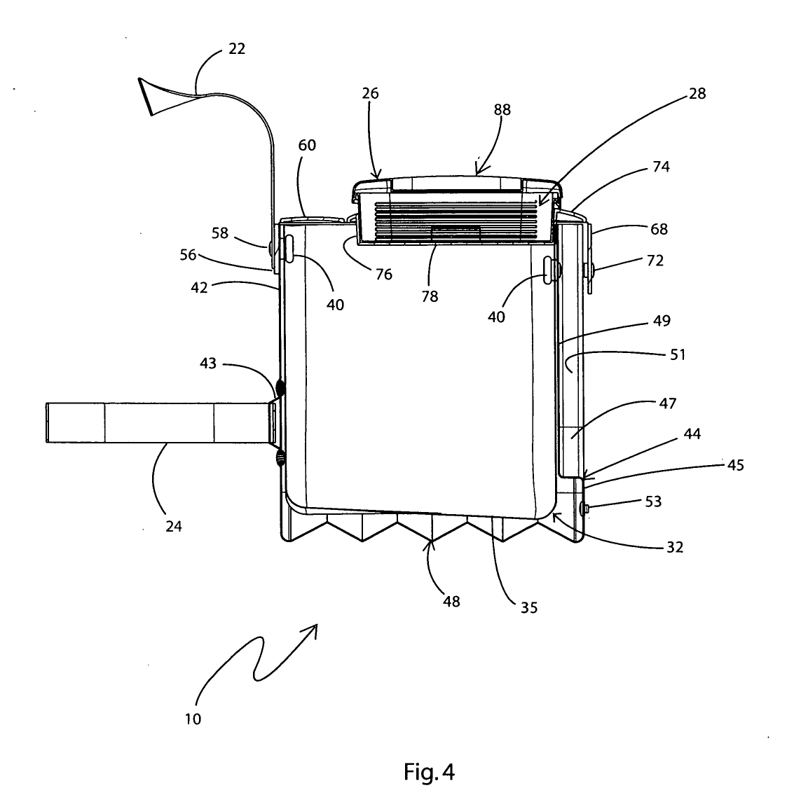

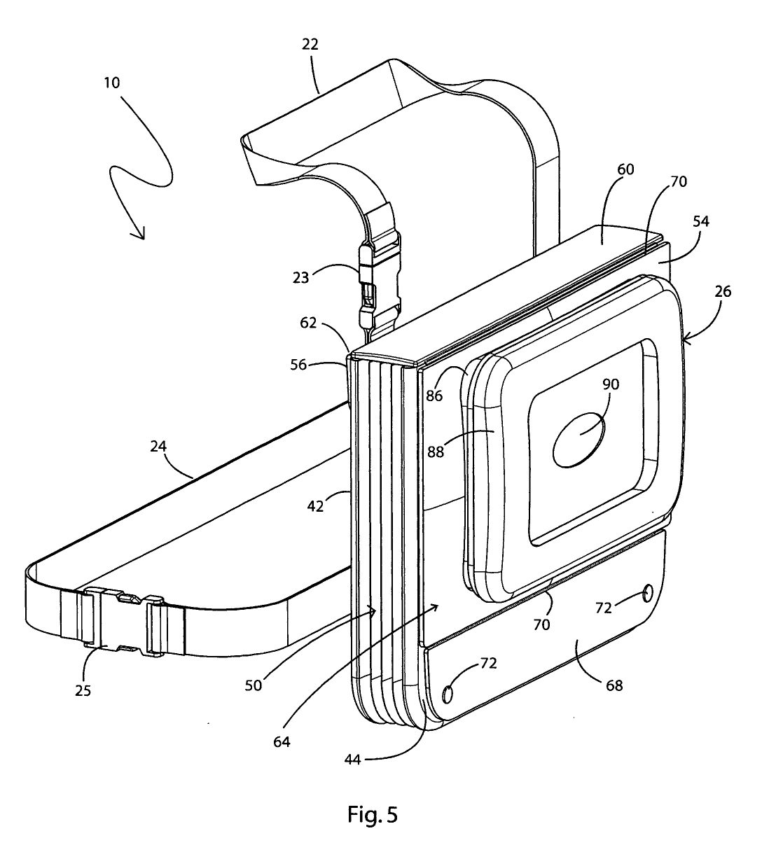

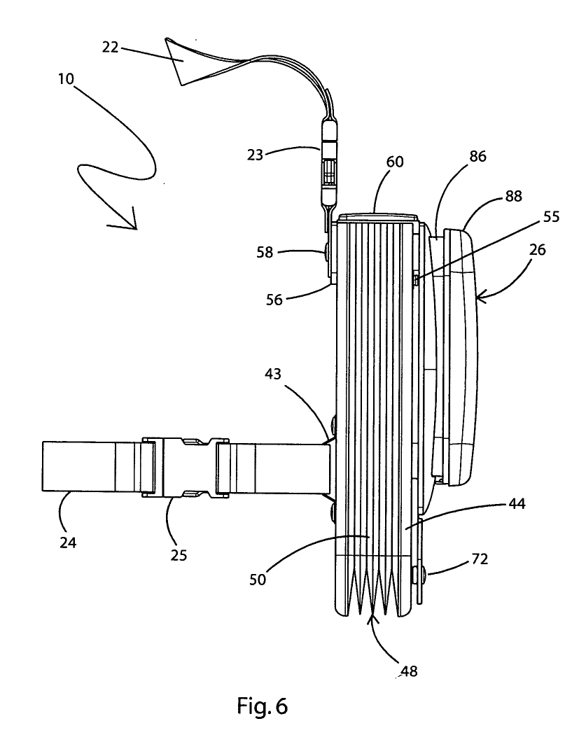

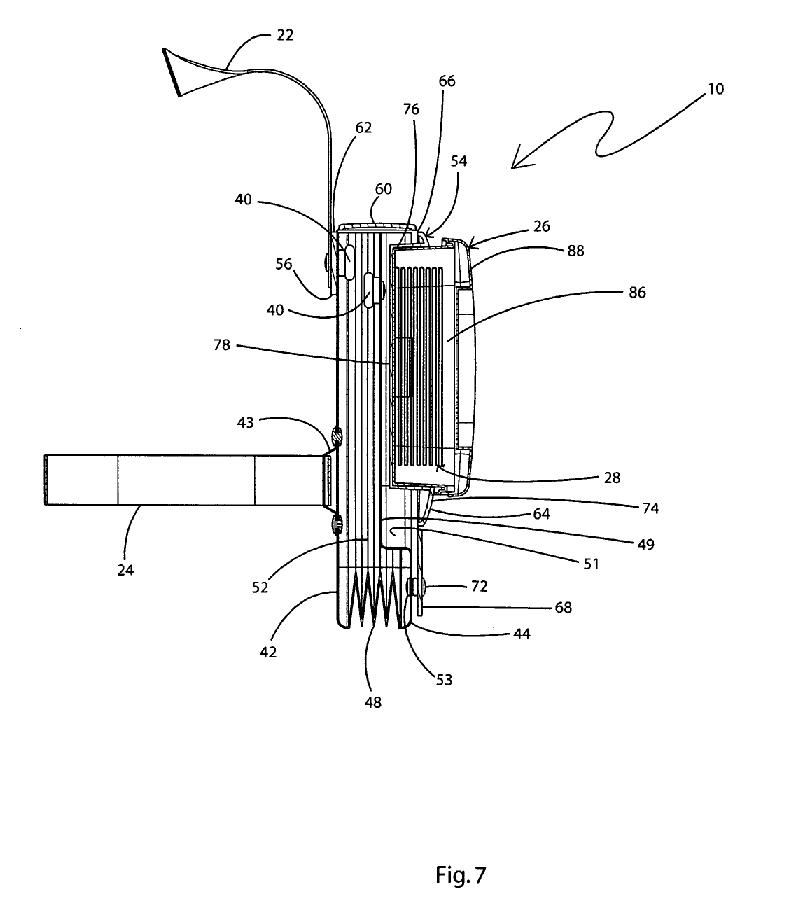

The trash container assembly of the present invention is indicated generally at 10 in FIGS. 1-3. Assembly 10 is configured primarily for use with a seat or chair such as an automotive seat for receiving trash during travel. Assembly 10 is thus typically used with a vehicular chair having a seat 12, a back 14 extending upwardly therefrom and a headrest 16 mounted on back 14 extending upwardly therefrom via a pair of posts 18 inserted into back 14. Assembly 10 includes a collapsible and expandable receptacle 20 and a seat mount including first and second adjustable straps 22 and 24 which are connected to receptacle 20 and extend outwardly therefrom to form respective loops. Quick release buckles 23 and 25 (FIG. 2) are respectively used with straps 22 and 24 to provide a quick release between the respective sections of said straps. First strap 22 loops around posts 18 of headrest 16 while second strap 24 loops around back 14 in order to secure receptacle 20 on back 14 with the front of receptacle 20 abutting the rear surface of back 14 so that receptacle 20 is snugly mounted on back 14. While the figures show receptacle 20 disposed behind back 14, receptacle 20 may be positioned in front of back 14 and snugly mounted in abutment with the front surface thereof. Assembly 10 may also include a compartment 26 which may be formed inwardly therewith or removably mounted thereon. Compartment 26 preferably is configured to contain pre-moistened wipes 28 (FIGS. 4 and 7), tissues or the like. Receptacle 20 is movable between an expanded position (FIGS. 1-4) and a collapsed position (FIGS. 5-7).

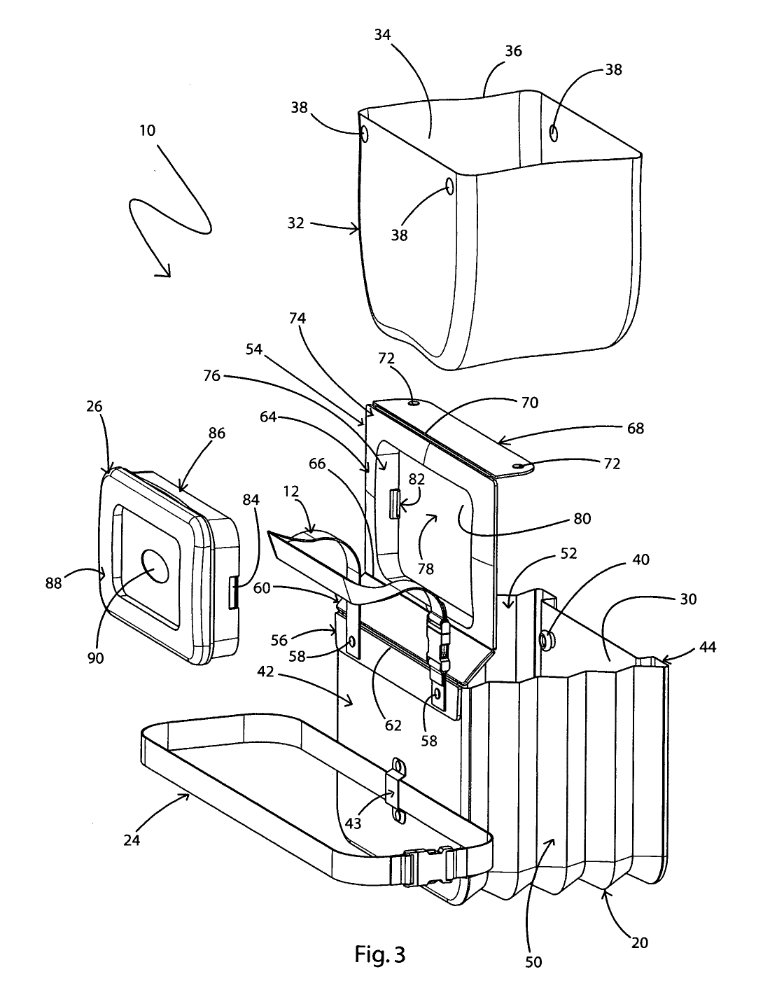

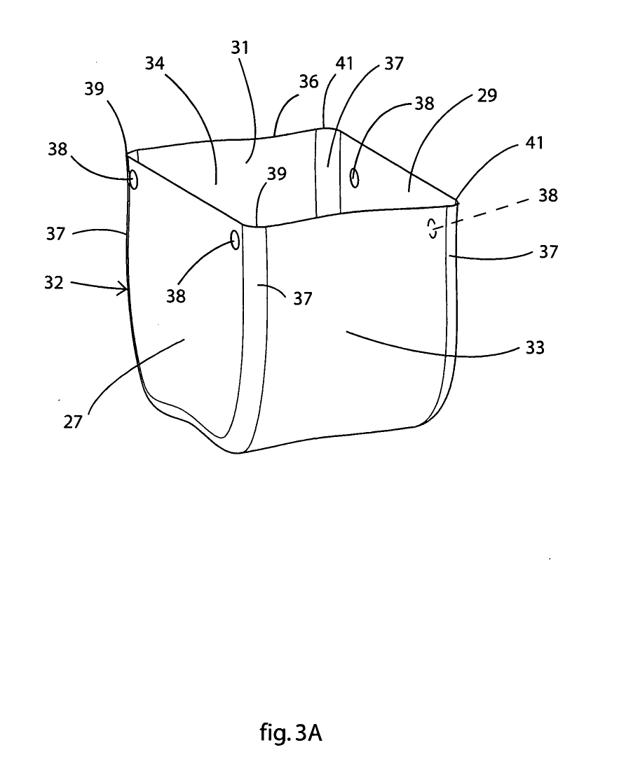

Referring to FIGS. 2-4, receptacle 20 defines an interior chamber 30 in which a flexible trash bag 32 is removably disposed. Bag 32 is preferably liquid-impermeable in order to retain liquids therein. Bag 32 is thus typically formed of a flexible plastic material. However, other bags may be formed of materials which may be liquid permeable if containment of liquids is not necessary. Bag 32 generally conforms to the walls of receptacle 20 so that an interior chamber 34 of bag 32 substantially mimics the interior chamber 30 of receptacle 20. Bag 32 has an upper end 36 defining an entrance opening into interior chamber 34. A plurality of mounting holes 38 are formed in bag 32 adjacent upper end 36 for mounting on respective projections 40 (FIGS. 3, 4 and 9) which extend inwardly from the front and rear walls of receptacle 20.

More particularly, and with reference to FIG. 3A, bag 32 includes a front panel 27, a rear panel 29, first and second side panels 31 and 33 and a bottom panel 35 (FIG. 4). Each of said panels is substantially flat when bag 32 is in an expanded position in order to conform to the respective inner surfaces of receptacle 20 when it is in the expanded position. Bag 32 further includes arcuate transition sections 37 which connect front panel 27 with each of side panels 31 and 33 and also connects rear panel 29 with each of side panels 31 and 33. Each of the arcuate transition sections 37 which are connected to front panel 27 terminate at upper end 36 at respective front upper corners 39 likewise, each of arcuate transition sections 37 which are connected to rear panel 29 terminate at upper end 36 in arcuate rear upper corners 41. A pair of the holes 38 are formed in front panel 27 respectively adjacent front upper corners 39. Likewise, a pair of the holes 38 are formed in rear panel 29 respectively adjacent rear upper corners 41 although the holes formed in panel 29 are slightly lower that those formed in panel 27 to accommodate the respective projections 40, as shown in FIG. 4.

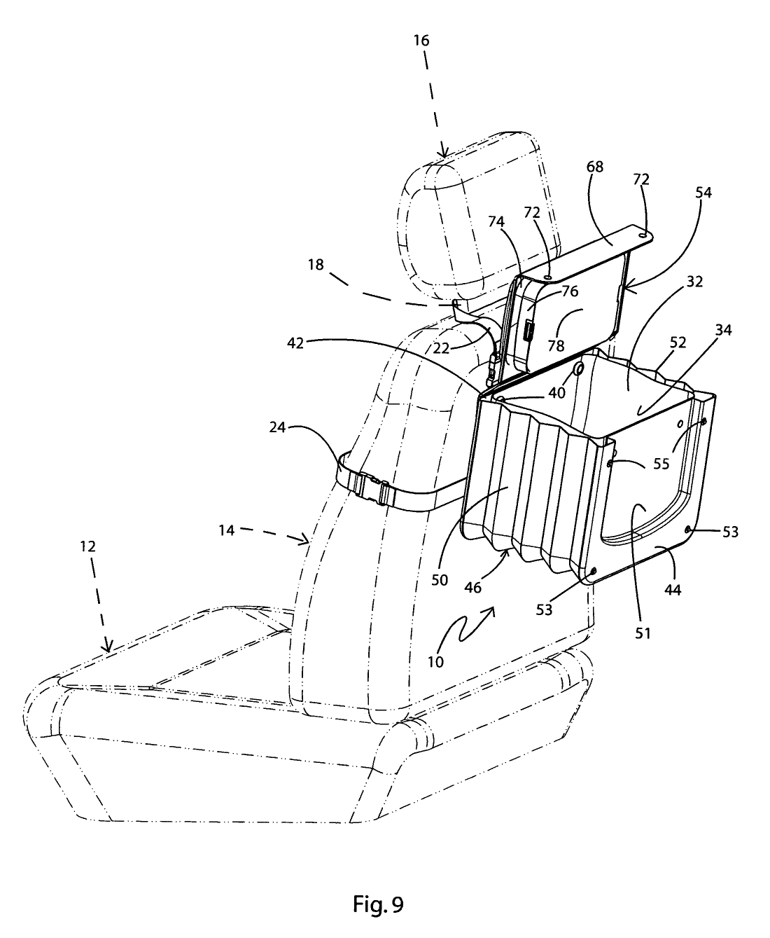

With continued reference to FIGS. 2-4, receptacle 20 includes rigid front and rear walls 42 and 44 which are connected by a collapsible wall in the form of an accordion-type wall 46. Wall 46 thus includes a plurality of panel sections which are folded back and forth in an accordion style so that wall 46 is collapsible and expandable. Wall 46 includes a bottom wall 48 and first and second spaced sidewalls 50 and 52 extending upwardly therefrom. A pair of projections 40 (only one shown) are thus rigidly attached to and extend forward from front wall 44 into interior chamber 30. Likewise, a pair of projections 40 (FIG. 9) extends rearwardly from front wall 42 into interior chamber 30. A mounting bracket 43 is mounted on front wall 42 for mounting thereon second strap 24.

Rear wall 44 includes a U-shaped outer wall 45 defining a U-shaped inner perimeter, a U-shaped sidewall 47 extending inwardly from the inner perimeter of outer wall 45 and a flat recessed wall 49 connected to sidewall 47 and disposed inwardly of outer wall 45 to form a recessed area 51. A lower set of first fastening members 53 is mounted on outer wall 44 adjacent its lower end. Similarly, an upper set of first fastening members 55 (FIG. 9) is mounted on outer wall 45 adjacent its upper end.

A foldable lid 54 formed of rigid or suitably rigid materials is pivotally mounted on receptacle 20 and movable between closed and open positions respectively shown in FIGS. 2 and 3. Lid 54 includes a mounting flange 56 which is secured to front wall 42 by a pair of fasteners 58 which also secure the projections 40 mounted on front wall 42. Fasteners 58 also secure respective ends of first strap 22 to front wall 42. Lid 54 further includes a spine panel 60 which is hingedly connected to mounting flange 56 by a hinge 62 such as a living hinge. Lid 54 further includes a main or top panel 64 hingedly connected to panel 60 by another hinge 66 which is typically a living hinge. A closing panel or flap 68 is hingedly mounted to main panel 64 by another hinge 70 which is also typically a living hinge. Hinges 62, 66 and 70 are parallel to one another. A pair of fastening members 72 is mounted on flap 68 for releasably securing flap 68 to receptacle 20 as further detailed below. Second fastening members 72 may alternately releasably engage upper first fastening members 55 or lower first fastening members 53 depending on the position of expandable receptacle 20.

Main wall 64 includes a rectangular top wall 74 which defines an inner perimeter, a rectangular sidewall 76 extending downwardly from the inner perimeter of top wall 74 and a flat recessed wall 78 disposed downwardly from top wall 74 and connected to sidewall 76 to form a recessed area 80 extending downwardly from top wall 74 when lid 54 is in the closed position. A retaining mechanism in the form of a pair of opposed retaining clips 82 (one shown in FIG. 3) is mounted on sidewall 76 for releasably securing compartment 26 when disposed within recess 80.

More particularly, a pair of retaining recesses 84 (one shown in FIG. 3) is formed in a base 86 of compartment 26 for releasably receiving clips 82. Base 86 thus comprises a generally rectangular bottom wall and generally rectangular sidewall which fits matingly within recess 80 with the bottom wall abutting recessed wall 78. Compartment 26 further includes a lid 88 which is openable and closable to allow for the insertion and removal of wipes 28 (FIG. 4). An access opening 90 may also be formed in lid 88 to allow for removal of wipes 28 therethrough while being configured to retain moisture within compartment 26.

When receptacle 20 is in the expanded position with walls 42 and 44 spaced apart, spine panel 60, top wall 74 and recessed wall 78 are generally horizontal and flap 68 is generally vertical and releasably connected to front wall 44 via the releasable connection between upper fastening members 55 and second fastening members 72. In the collapsed position of receptacle 20 shown in FIGS. 5-7, rear wall 44 moves toward front wall 42 while maintaining a generally vertical position of each of said walls as wall 46 collapses. In this collapsed position with lid 54 closed, spine panel 60 remains in a substantially horizontal position while main panel 64 has pivoted downwardly via hinge 66 so that top wall 74 and recessed wall 78 are substantially vertically oriented along with flap 68 which is releasably connected to rear wall 44 via the releasable connection between connecting members 53 and 72. Thus, when assembly 10 is not in use, it may be stored in the relatively compact position shown in FIGS. 5-7 with front and rear walls 42 and 44 substantially parallel to back 14 or the rear surface thereof. To help achieve this compact configuration, recessed wall 78 and sidewall 76 are received within recessed area 51 of front wall 44.

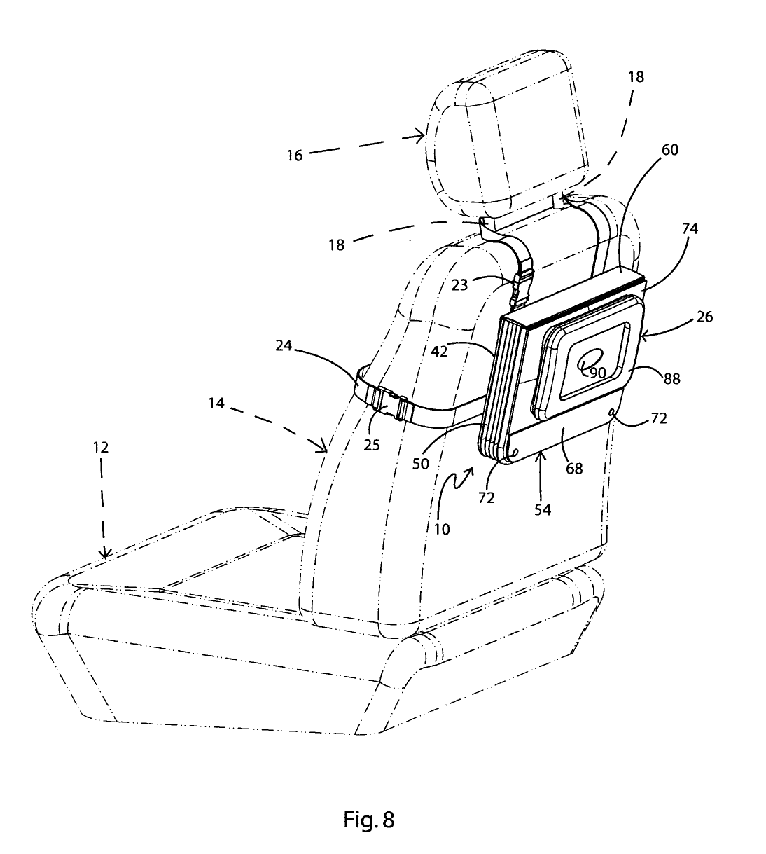

Referring to FIGS. 8-9, the operation of assembly 10 is further detailed. To install assembly 10, first strap 22 is looped around posts 18, secured with buckle 23 and tightened as needed. Second strap 24 is also looped around back 14, buckled with 25 and tightened as needed to secure receptacle 20 on back 14 preferably abutting the rear surface thereof and snuggly secured thereto to prevent the tipping of receptacle 20 and bag 32. Wipes 28, tissues or the like may be removed from compartment 26 via opening 90 or by opening lid 88 regardless of the position of receptacle 20. In order to use receptacle 20, fastening members 72 are released from fastening members 53 so that lid 54 may be pivoted upwardly via the hinge or hinges thereof so that rear wall 44 may move rearwardly via the expansion of wall 46. Lid 54 may then be opened as shown in FIG. 9 to allow access to interior chamber 34 of bag 32 in order to dispose trash therein. Lid 54 may then be lowered with receptacle 20 in the expanded position and flap 68 secured to the upper portion of wall 44 via the releasable connection of fastening members 72 and 55, as shown in FIG. 1.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A trash container assembly for use with a seat assembly having a seat and a back extending upwardly therefrom, the trash container assembly comprising:
a trash receptacle movable between collapsed and expanded positions; and
a seat mount adapted for mounting the receptacle on the back of the seat assembly.

2. The trash container assembly of claim 1 wherein the receptacle comprises a collapsible wall.

3. The trash container assembly of claim 2 wherein the collapsible wall is an accordion type wall.

4. The trash container assembly of claim 2 wherein the receptacle comprises a first rigid wall connected to the collapsible wall.

5. The trash container assembly of claim 4 wherein the receptacle comprises a second rigid wall connected to the collapsible wall.

6. The trash container assembly of claim 1 further comprising a trash bag disposed within the receptacle.

7. The trash container assembly of claim 6 further comprising a plurality of projections connected to the receptacle; and a plurality of holes formed in the bag for respectively receiving therein the projections to mount the bag on the receptacle.

8. The trash container assembly of claim 1 further comprising a lid connected to the receptacle.

9. The trash container assembly of claim 8 further comprising a first releasable connection between the lid and receptacle in the collapsed position; and a second releasable connection between the lid and receptacle in the expanded position.

10. The trash container assembly of claim 9 wherein the lid is positionable beside the receptacle in the collapsed position and atop the receptacle in the expanded position.

11. The trash container assembly of claim 10 wherein the receptacle comprises a first rigid wall having upper and tower ends; the first connection is adjacent the lower end of the first wall; and the second connection is adjacent the upper end of the first wall.

12. The trash container assembly of claim 8 further comprising a compartment carried by the lid.

13. The trash container assembly of claim 12 wherein the receptacle comprises a sidewall defining a recessed area in which the compartment is received in the collapsed position.

14. The trash container assembly of claim 1 wherein the seat mount comprises a first strap mounted on the receptacle.

15. The trash container assembly of claim 14 wherein the seat mount comprises a second strap mounted on the receptacle.

16. The trash container assembly of claim 1 further comprising a compartment mounted on the receptacle.

17. The trash container assembly of claim 16 wherein the compartment is pivotally mounted on the receptacle.

18. The trash container assembly of claim 16 further comprising a plurality of pre-moistened wipes disposed in the compartment.

19. The trash container assembly of claim 16 wherein the compartment is positionable beside the receptacle in the collapsed position and atop the receptacle in the expanded position.

20. The trash container assembly of claim 19 wherein the receptacle comprises a sidewall defining a recessed area in which the compartment is received in the collapsed position
